(19) United States
(12) Patent Application Publication
(10) Pub. No.: US 2011/0313546 A1
(43) Pub. Date: Dec. 22, 2011

(54) OPERATION AND OBSERVATION APPARATUS

(75) Inventors: Yoshihiro Ikegaya, Tokyo (JP); Hiraku Hamachi, Tokyo (JP); Satoshi Asawa, Tokyo (JP)

(73) Assignee: YOKOGAWA ELECTRIC CORPORATION, Tokyo (JP)

(21) Appl. No.: 13/165,274

(22) Filed: Jun. 21, 2011

(30) Foreign Application Priority Data
Jun. 21, 2010 (JP) 2010-140458

(51) Int. Cl. G05B 15/02

(52) U.S. Cl. 700/3

(57) ABSTRACT

An operation and observation apparatus which supervises and manages a server equipped with at least one main controller and a plurality of sub-controllers each for controlling a process, the sub-controllers being managed by the main controller, has a view definer for defining a plurality of views by selecting a parameter desired by a user to be operated and observed from a list-and-display screen of all parameters registered on the server, the parameters each belonging to a layer of or below the main controller, a user assignor for assigning every user the defined plural views, and a view registerer for registering each of the views assigned to every user on the list-and-display screen as an imaginary controller.

### BACKGROUND

1. Field

The present disclosure relates to an operation and observation apparatus which supervises and manages a server equipped with at least one main controller and a plurality of sub-controllers for process control managed by the main controller.

2. Description of the Related Art

FIG. 7 shows a functional block diagram which illustrates an exemplary structure of a multivariable model predictive control system having an operation and observation apparatus as a high-end apparatus. The operation and observation apparatus 10 has an operation and observation screen 11, and supervises and manages one server 30 through a communication bus 20.

The server 30 is equipped with two main controllers 31 and 41. The main controller 31 manages two sub-controllers 32 and 33. The sub-controller 32 communicates with a device in a process 50 so as to control the process. The sub-controller 33 communicates with a device in a process 60 so as to control the process.

Similarly, the main controller 41 manages two sub-controllers 42 and 43. The sub-controller 42 communicates with a device in a process 70 (not illustrated in detail) so as to control the process. The sub-controller 43 communicates with a device in a process 80 (not illustrated in detail) so as to control the process.

The main controller 31 and the sub-controllers 32 and 33 form physical layers of the controllers. Similarly, the main controller 41 and the sub-controllers 42 and 43 form physical layers of the controllers.

Incidentally, the operation and observation apparatus 10 can supervise and manage a plurality of servers, and each of the servers can have a plurality of main controllers. The main controllers each can have three or more sub-controllers.

The main controllers and the sub-controllers in the server 30 form a multivariable model predictive control system equipped with models of the processes 50-80. The processes each define parameters of the process, e.g., MV: an operation variable, CV: a control variable, POV: a process output variable, DV: a disturbance variable, etc. for the sub-controller which controls the process. The sub-controller carries out a multivariable model predictive control operation on the basis of the defined parameters.

FIG. 8 illustrates an exemplary basic operation done on an ordinary operation and observation screen being displayed. The operation and observation screen includes a browser screen 11a illustrated in FIG. 8A and a detailed screen 11b illustrated in FIG. 8B so that values of various kinds of parameters are displayed and set.

The browser screen 11a illustrates a list-and-display screen for all parameters to be used for the multivariable model predictive control in a tree-like format. The tree illustrates physical layers of the controllers. Upon each of the parameters being clicked, the detailed screen 11b of the relevant parameter on which various kinds of information staying at the parameter are referred to or a value is set to the parameter opens.

FIG. 9 is an exemplary entire observation screen displayed on an ordinary operation and observation screen. The browser screen 11a to list and display the physical layers of the controllers is displayed, and an overview of all parameters which belong to the sub-controllers 32 and 33 of the selected main controller 31 is displayed on the detailed screen 11b.

An article titled “Advanced Process Control for Ultra-Deep-Hydrodesulfurization Using Exasmoc R3 and Exarqe R3” in Yokogawa Technical Report Vol. 47, No. 4 (2003) is an example of related art.

In general, operation and observation of multivariable model predictive control is performed by various users, not by one and the same user every time. Parameters to be observed or regarded as important differ depending upon the users. The ordinary browser screen uniformly displays a list of the physical layers of the controllers at all times.

What is observed by the user, however, does not necessarily agree with the physical layers of the controllers. A certain parameter needs to be operated and observed across a boundary of plural main controllers as a target to be observed.

According to an ordinary display method, a piece of information being unnecessary for a particular user is displayed. Thus, the user tends to be in danger of an erroneous operation resulting in that an erroneous value is set, etc.

### SUMMARY OF THE DISCLOSURE

Accordingly, it is an object of the disclosure to provide an operation and observation apparatus configured to display only pieces of information necessary for a user together without being restricted by a physically layered structure formed by a plurality of controllers even if a target to be observed spans a boundary of a plurality of main controllers.

In order to achieve the above advantage, the disclosure is structured as follows.

(1) An operation and observation apparatus which supervises and manages a server equipped with at least one main controller and a plurality of sub-controllers each for controlling a process, the sub-controllers being managed by the main controller, the operation and observation apparatus having a view definer for defining a plurality of views by selecting a parameter desired by a user to be operated and observed from a list-and-display screen of all parameters registered on the server, the parameters each belonging to a layer of or below the main controller; a user assignor for assigning every user the defined plural views; and a view registerer for registering each of the views assigned to every user on the list-and-display screen as an imaginary controller.

(2) The operation and observation apparatus according to (1), wherein the server is formed by a plurality of server devices; and all the parameters registered on the plural server devices are listed and displayed on the list-and-display screen.

(3) The operation and observation apparatus according to one of (1) and (2), wherein the view definer defines a set of a name of a control variable communicated between the process and the sub-controller and a tag name of the sub-controller by giving the set a unique view name; and the view registerer registers each of the views assigned to every user as an imaginary controller including the view name as a first layer on the list-and-display screen.

(4) The operation and observation apparatus according to (3), wherein upon the view name being clicked, the set of the name of the control variable and the tag name of the sub-controller and a name of a detailed parameter belonging to the set are displayed on a pop-up window on the list-and-display screen.

(5) The operation and observation apparatus according to one of (1) through (4), wherein the view definer, the view registerer and the user assignor are produced through a builder, the server and the builder being connected and enabled to communicate with each other.

(6) The operation and observation apparatus according to one of (1) through (5), wherein the main controller and the sub-controllers form a multivariable model predictive control system having a model of the process.

It is expected that the disclosed features have the following effects.

(1) As a view function is implemented, pieces of information necessary for a user can be displayed together without being restricted by a physically layered structure formed by a plurality of controllers even if a target to be observed spans a boundary of a plurality of main controllers. That is, a screen can be displayed with respect to the user's target to be observed.

(2) As no piece of information unnecessary for the user is displayed on the operation and observation screen, the scope of the observation is made clear, and the system can be enhanced in security such that a user's erroneous operation is prevented.

### BRIEF DESCRIPTION OF THE DRAWINGS

FIG. 1 shows an exemplary basic operation done on an operation and observation screen that the disclosure is applied to;

FIG. 2 shows an exemplary view definition screen produced by a builder;

FIG. 3 shows an exemplary user assignment screen produced by the builder;

FIG. 4 shows an exemplary display of an entire observation screen of an operation and observation apparatus that the disclosure is applied to;

FIG. 5 shows a functional block diagram which illustrates an exemplary structure of a multivariable model predictive control system having a plurality of servers;

FIG. 6 shows another exemplary display of an entire observation screen of an operation and observation apparatus that the disclosure is applied to;

FIG. 7 shows a functional block diagram which illustrates an exemplary structure of a multivariable model predictive control system having an operation and observation apparatus as a high-end apparatus;

FIG. 8 illustrates an exemplary basic operation done on an ordinary operation and observation screen being displayed; and

FIG. 9 is an exemplary entire observation screen displayed on an ordinary operation and observation screen.

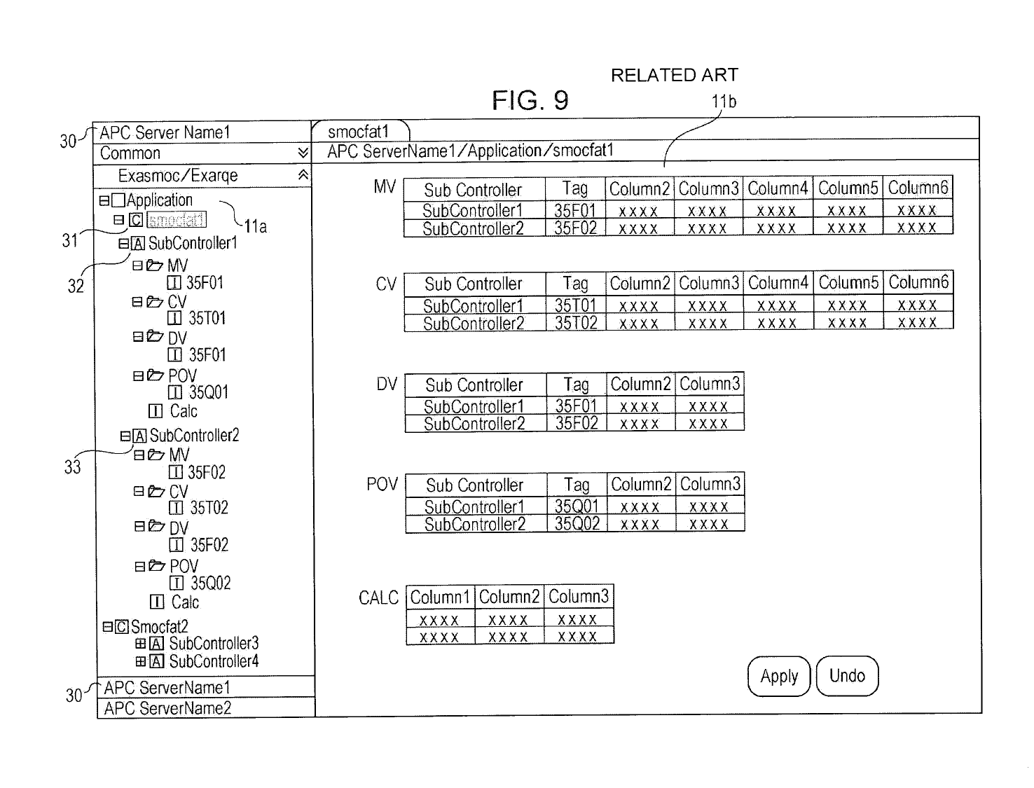

### DESCRIPTION OF THE PREFERRED EMBODIMENTS

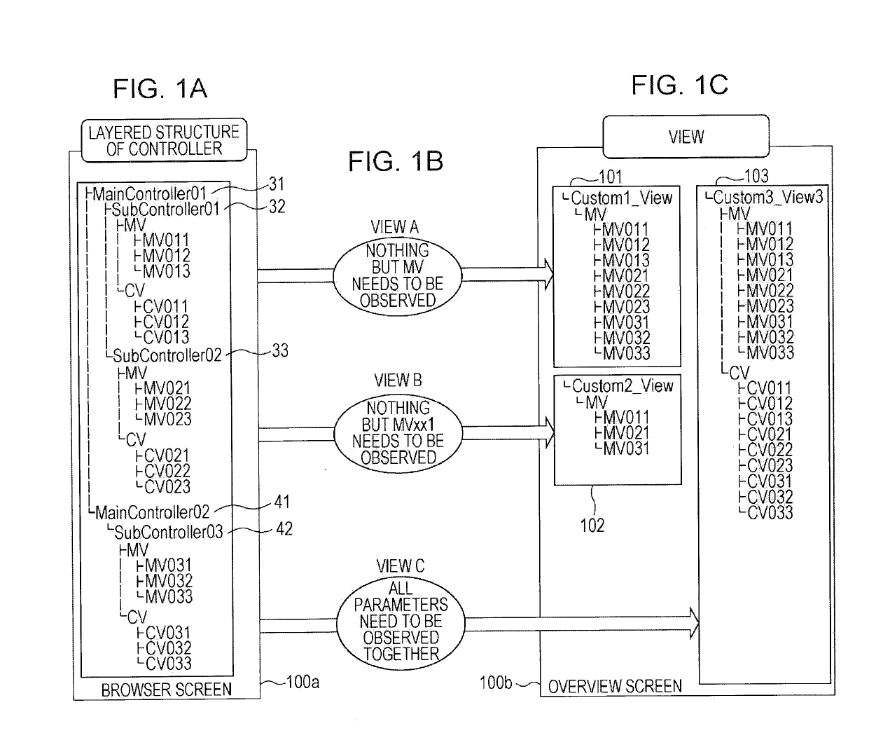

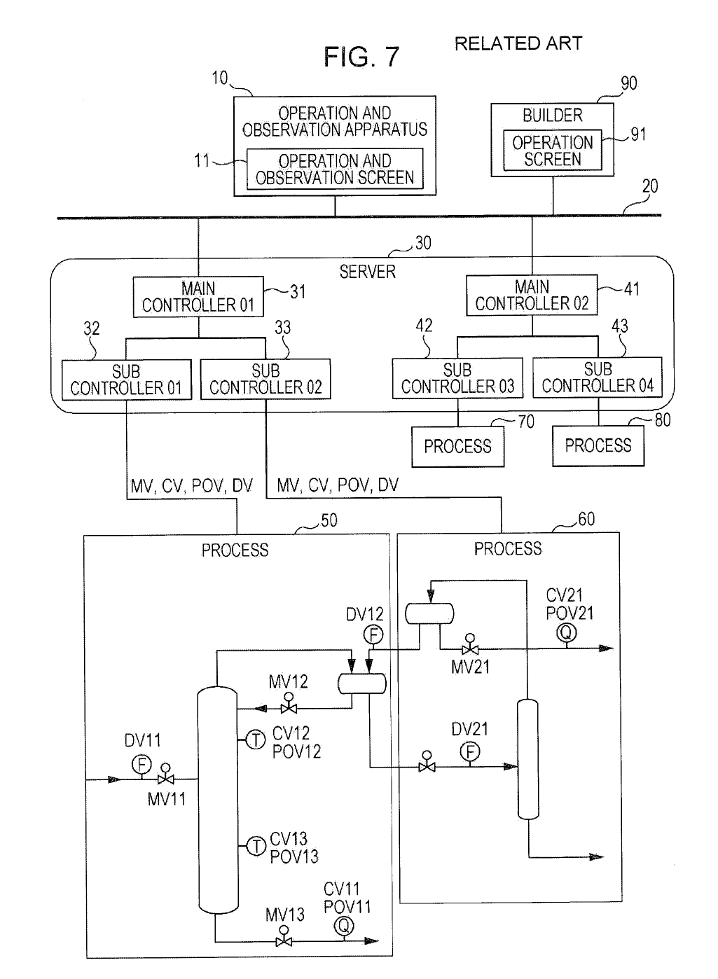

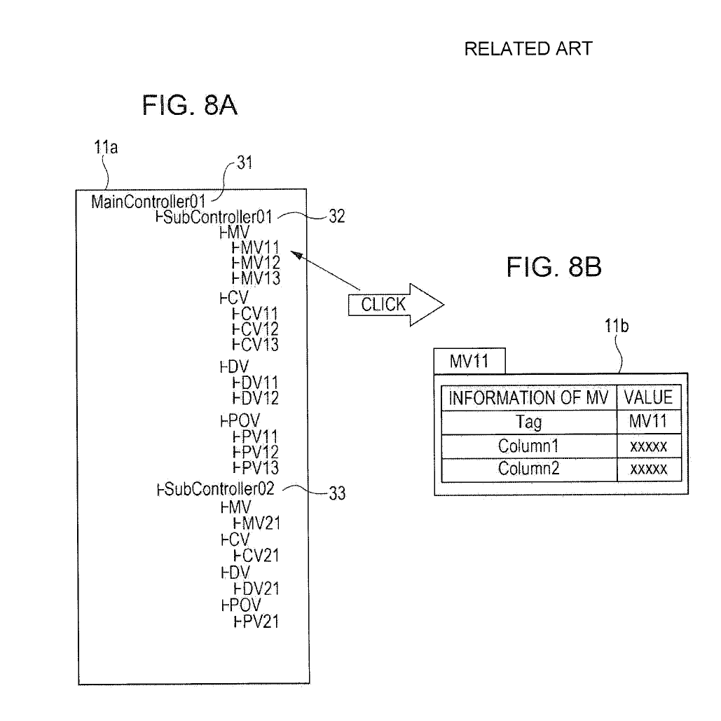

The disclosure will be explained in detail by the use of the drawings. FIG. 1A to 1C shows an exemplary basic operation done on an operation and observation screen that the disclosure is applied to. A component which is a same as one included in the ordinary structure explained with reference to FIGS. 7 and 8 is given a same reference numeral, and its explanation is omitted.

FIG. 1A to 1C shows an exemplary basic operation in a case where the disclosure is applied to the control system shown in FIG. 7. FIG. 1A shows a browser screen 100a which lists and displays a layered structure formed by controllers. FIG. 1B shows how views produced by the disclosure are put into practice. FIG. 1C shows an overview screen 100b on which the views resultantly put into practice are displayed.

A view A is a view aimed at observing nothing but parameters MV belonging to the sub-controllers 32, 33 and 42 across the main controllers 31 and 41, and is resultantly put into practice as illustrated on an overview screen 101.

The overview screen 101 displays parameters MV011, MV012 and MV013 of the sub-controller 32, parameters MV021, MV022 and MV023 of the sub-controller 33, and parameters MV031, MV032 and MV033 of the sub-controller 42.

A view B is a view aimed at observing nothing but parameters MVxx1 belonging to the sub-controllers 32, 33 and 42 across the main controllers 31 and 41, and is resultantly put into practice as illustrated on an overview screen 102.

The overview screen 102 displays the parameters MV011, MV021 and MV031 of the sub-controllers 32, 33, and 42, respectively.

A view C is a view aimed at observing all parameters belonging to the sub-controllers 32, 33 and 42 across the main controllers 31 and 41 together, and is resultantly put into practice as illustrated on an overview screen 103. The overview screen 102 displays all parameters belonging to the sub-controllers 32, 33 and 42.

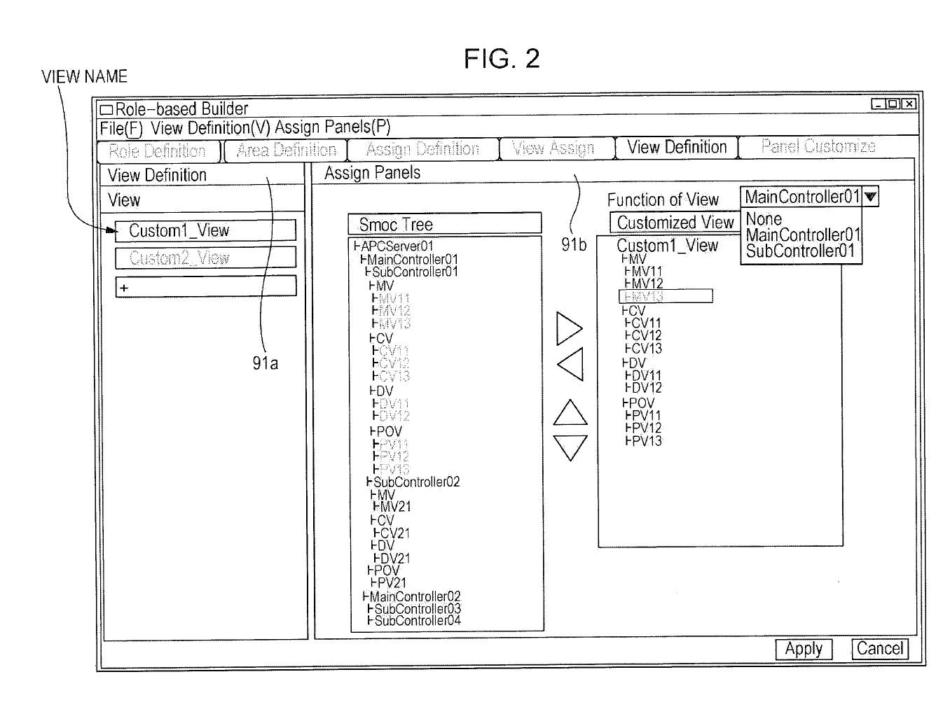

FIG. 2 shows an exemplary view definition screen produced by a view definer that a builder 90 is provided with. An operation screen 91 of the builder 90 displays a view definition screen 91a and an assignment screen 91b of left and right portions of the screen, respectively. A view name to be defined is entered on the view definition screen 91a.

On the assignment screen 91b, a parameter desired to be displayed is identified in all the parameters in the layered structure formed by the controllers listed and displayed in a tree-like format on a left-hand side of the screen, and is shifted to a selection screen on a right-hand side of the screen. A turn to be displayed can be changed as well.

The view name to be defined on the view definition screen 91a is defined with a name unique to a set of a name of a control variable communicated between a process and a sub-controller and a tag name of the sub-controller.

A view registerer that the builder 90 is provided with registers a view as an imaginary controller on a list-and-display screen of a tree-like format including a view name as a first layer. Repeat the above operation so that a plurality of views can be defined and registered. A user can thereby implement a view screen which serves his or her purpose as he or she likes.

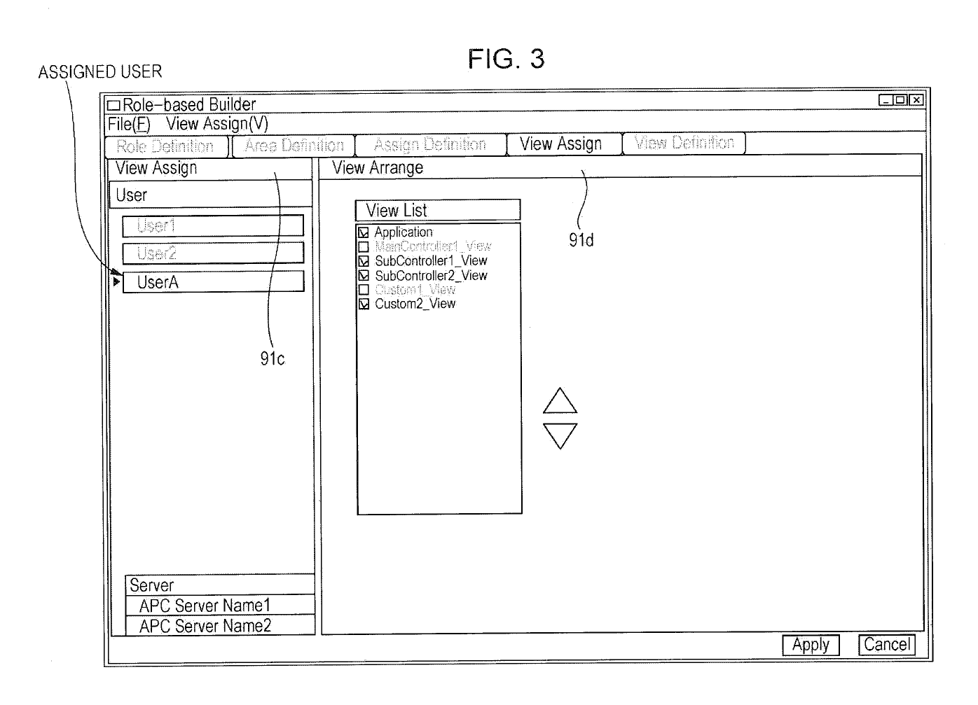

FIG. 3 shows an exemplary user assignment screen produced by the builder 90. This is a screen on which users are assigned plural views having been made on the view definition screen shown in FIG. 2. The users each can be assigned plural view desired to be displayed.

An assigned user's name is entered on a view assignment screen 91c displayed on a left portion of the screen. Views to be assigned in the list of the plural views having been made are entered by being checked on a view arrangement screen 91d displayed on a right portion of the screen.

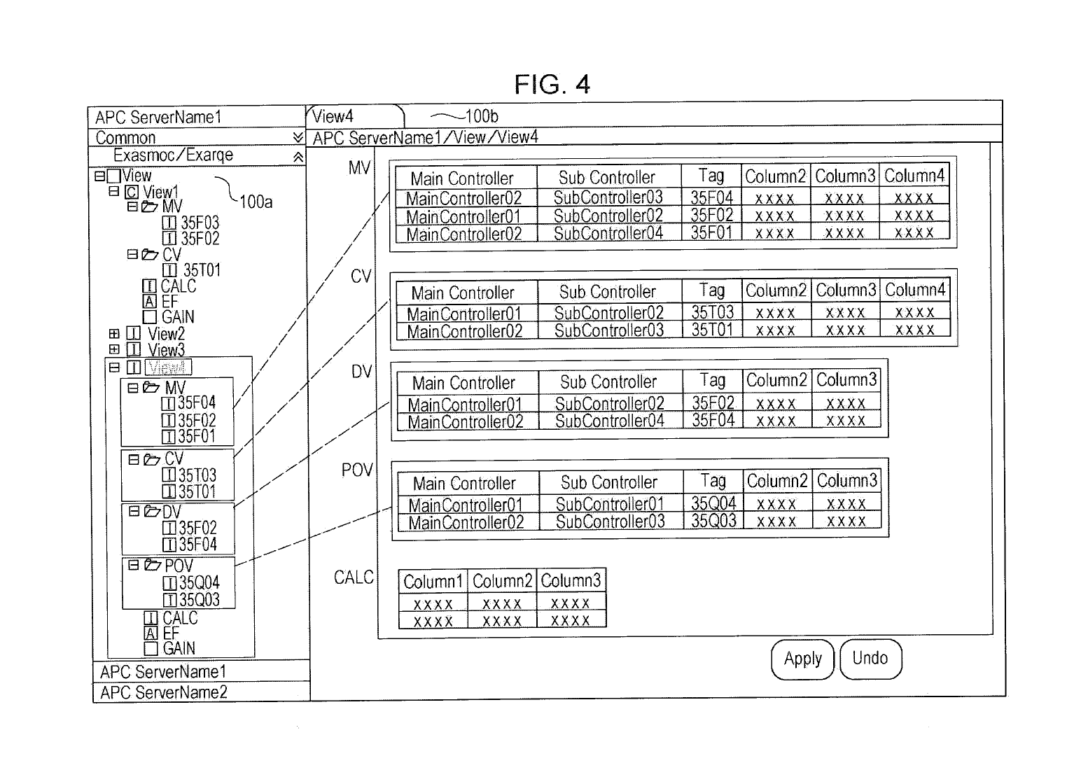

FIG. 4 shows an exemplary display of an entire observation screen of the operation and observation apparatus that the disclosure is applied to. A layered structure formed by the views is displayed in a tree-like format on the browser screen 100a on a left portion of the screen in addition to the layered structure formed by the controllers in a tree-like format across the plural main controllers.

That is, the views can be regarded as controllers forming an imaginary layered structure. If a view name (View4) is clicked on the browser screen 100a, a set of control variable names and sub-controller's tag names and detailed names of parameters belonging to the set are displayed on the overview screen 100b.

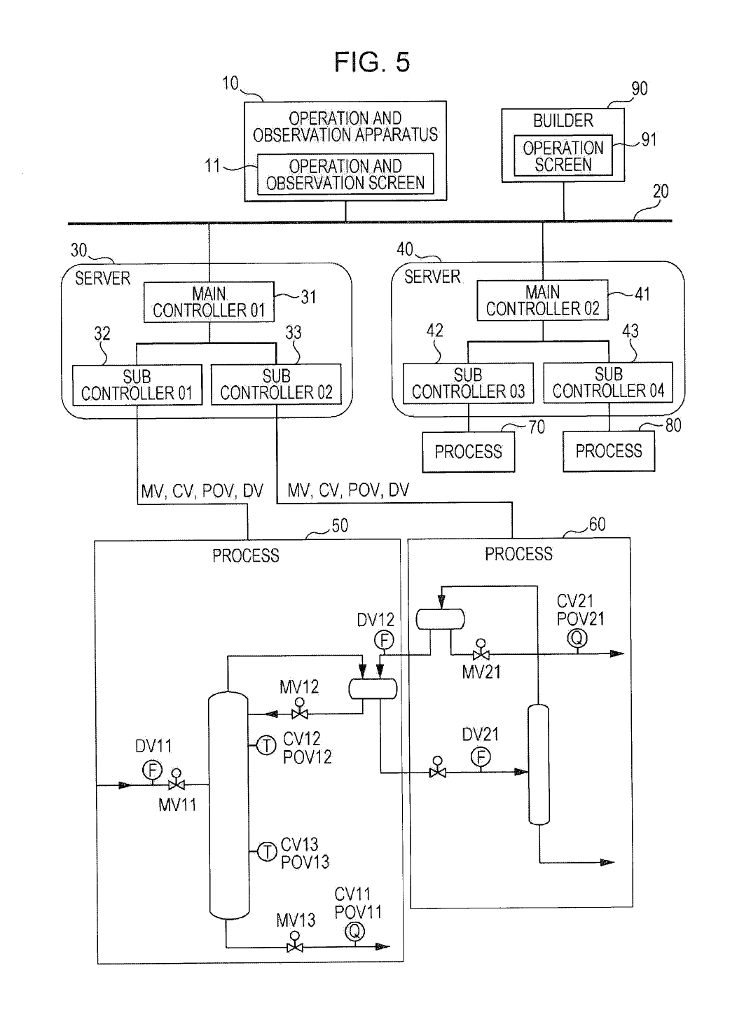

FIG. 5 shows a functional block diagram which illustrates an exemplary structure of a multivariable model predictive control system having a plurality of servers. The structure shown in FIG. 5 differs from the structure of the system formed by a single server shown in FIG. 7 in that the operation and observation apparatus 10 supervises and manages the two servers 30 and 40 and that the server 40 is equipped therein with the main controller 41 and the sub-controllers 42 and 43.

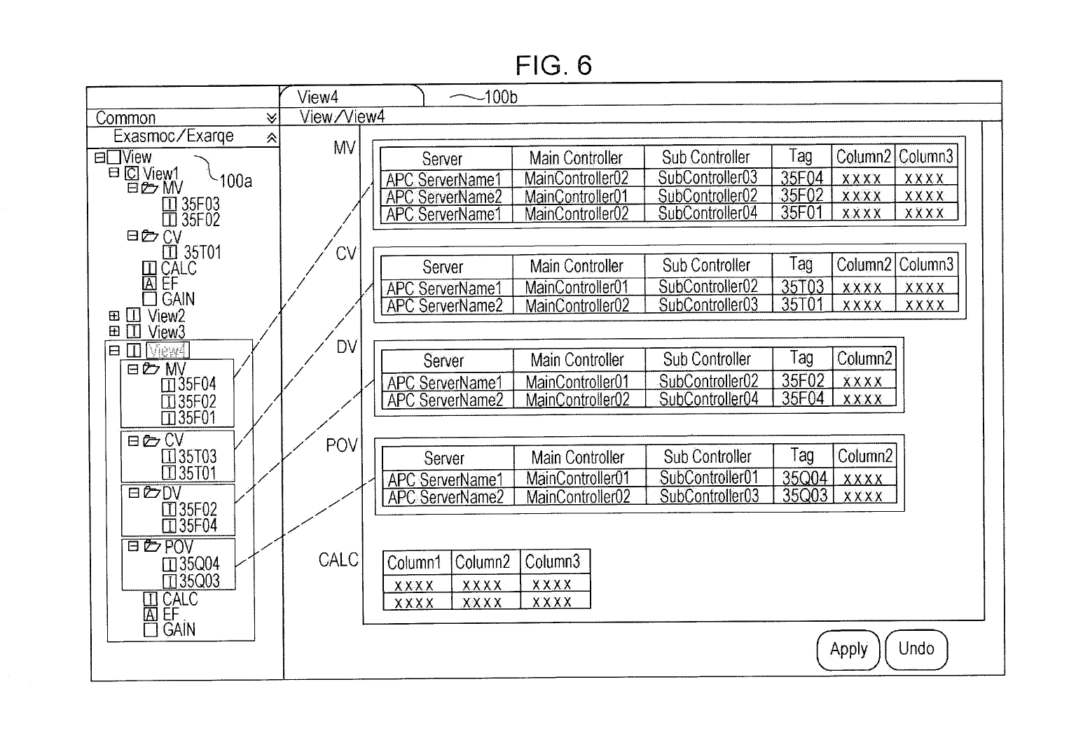

FIG. 6 shows another exemplary display of an entire observation screen of an operation and observation apparatus that the disclosure is applied to, on which the parameters to be used across the plural servers shown in FIG. 5 can be displayed on one operation and observation screen.

A layered structure formed by the views is displayed in a tree-like format on the browser screen 100a on a left portion of the screen in addition to the layered structure formed by the controllers listed and displayed in a tree-like format across the plural main controllers included in the plural servers.

If a view name (View4) is clicked on the browser screen 100a, a set of control variable names and sub-controller's tag names and detailed names of parameters belonging to the set are displayed on the overview screen 100b in association with server names and main controller names.

While embodiments of the present disclosure have been particularly shown and described with reference to exemplary embodiments thereof, it will be understood by those of ordinary skill in the art that various changes in form and details may be made therein without departing from the spirit and scope of the present invention as defined by the following claims.

1. An operation and observation apparatus which supervises and manages a server equipped with at least one main controller and a plurality of sub-controllers each for controlling a process, the sub-controllers being managed by the main controller, the operation and observation apparatus comprising:
a view definer for defining a plurality of views by selecting a parameter desired by a user to be operated and observed from a list-and-display screen of all parameters registered on the server, the parameters each belonging to a layer of or below the main controller;
a user assignor for assigning every user the defined plural views; and
a view registerer for registering each of the views assigned to every user on the list-and-display screen as an imaginary controller.

2. The operation and observation apparatus according to claim 1, wherein:
the server is formed by a plurality of server devices; and
all the parameters registered on the plural server devices are listed and displayed on the list-and-display screen.

3. The operation and observation apparatus according to one of claims 1 and 2, wherein:
the view definer defines a set of a name of a control variable communicated between the process and the sub-controller and a tag name of the sub-controller by giving the set a unique view name; and
the view registerer registers each of the views assigned to every user as an imaginary controller including the view name as a first layer on the list-and-display screen.

4. The operation and observation apparatus according to claim 3, wherein:
upon the view name being clicked, the set of the name of the control variable and the tag name of the sub-controller and a name of a detailed parameter belonging to the set are displayed on a pop-up window on the list-and-display screen.

5. The operation and observation apparatus according to claim 3, wherein:
the view definer, the view registerer and the user assignor are produced through a builder, the server and the builder being connected and enabled to communicate with each other.

6. The operation and observation apparatus according to claim 3, wherein:
the main controller and the sub-controllers form a multivariable model predictive control system having a model of the process.

7. A server observation system which observes a parameter of a server equipped with a controller for controlling a process, the system comprising:
a view definer which allows a user to select an arbitrarily given parameter related to said controller and defines a view for displaying the selected parameter, and
a view performer which displays the parameter selected by the user by performing said view.

8. The server observation system according to claim 7, wherein the view definer defines the view for displaying the parameter related to a plurality of different controllers.

9. The server observation system according to claim 8, wherein said controller comprises a main controller and a plurality of sub-controllers which belong to the main controller.

10. The server observation system according to claim 9, wherein said server comprises a plurality of the main controllers.

11. The server observation system according to claim 10, further comprising a plurality of the servers.

12. The server observation system according to claim 7, wherein the view definer shows a list of parameters related to said controller and allows the user to select the parameter from the shown list.

13. The server observation system according to claim 7,
wherein the view definer gives the defined view a view name related to the selected parameter, and
wherein the view performer allows the user to select the view name, thereby determining the view to be performed.

14. The server observation system according to claim 7, further comprising:
a user assignor which assigns the view to an arbitrarily given user.

15. The server observation system according to claim 14, further comprising:
a user registerer which displays the view assigned to each user as an imaginary controller which is a first layer of a layered structure of said at least one controller.
